(19) United States
(12) Patent Application Publication
(10) Pub. No.: US 2020/0148358 A1
(43) Pub. Date: May 14, 2020

(54) POWERED DUMP GATE SYSTEM ON A CROP DUSTER

(71) Applicant: Troy Robert Reabe, Duluth, MN (US)

(72) Inventor: Troy Robert Reabe, Duluth, MN (US)

(21) Appl. No.: 16/191,424

(22) Filed: Nov. 14, 2018

(51) Int. Cl. B64D 1/16; E05F 15/53; E05F 15/611

(52) U.S. Cl. CPC B64D 1/16; E05F 15/53; E05Y 2900/53; E05Y 2201/448; E05Y 2900/502; E05F 15/611

(57) ABSTRACT

A crop duster dump gate opens and closes to turn on and off the flow of payload out of the hopper. The traditional mechanical gate is actuated by the pilot through mechanical linkages. The effort required by the pilot to open and close the gate requires significant force and can lead to fatigue or injury. The powered dump gate system is an add-on to the existing traditional mechanical gate system by a booster that is hydraulic, pneumatic, or electric. The powered dump gate eliminates strenuous effort by the pilot and requires no change to the pilot's work environment and methods.

### REFERENCE TO RELATED APPLICATIONS

This patent application claims the benefit of U.S. Provisional Application No. 62/585,972 filed on Nov. 14, 2017, the disclosure of which is incorporated herein by reference in its entirety.

### BACKGROUND OF THE INVENTION

### Field of the Invention

The present invention relates to a method and system for controlling crop duster dump gate, and more particularly to booster mechanisms for assisting a pilot in operating the controls of the dump gate.

### Description of Related Art

A crop duster dump gate opens and closes to turn on and off the flow of payload out of the aircraft payload hopper. The traditional mechanical gate is actuated by the pilot through mechanical linkages. The effort required by the pilot to open and close the gate requires significant force and can lead to fatigue or injury.

The only other device used in the field is a hydraulic dump gate where the traditional linkages and bell cranks are removed and replaced by a complex controller that electrically sends commands to the gate. The hydraulic system requires additional pilot training, adds distraction to the pilot, stops working when a failure occurs, and is very expensive.

Therefore, there exists a need for a system and method that is an add-on to the existing traditional mechanical gate system to assist a pilot to turn on and off the flow of payload out of the hopper.

### SUMMARY OF THE INVENTION

The powered dump gate system disclosed herein according to the present invention is an add-on to the existing traditional mechanical gate system by a booster that is hydraulic, pneumatic, or electric. The powered dump gate system eliminates strenuous effort by the pilot and requires no change to the pilot's work environment and methods. The invention claimed here solve the problem stated above.

The claimed invention differs from what currently exists. This invention is an improvement on what currently exists. For the pilot, the powered dump gate system is an add-on and operates like the traditional mechanical gate except it requires less physical effort.

The powered dump gate system mounts between the pilot's input bell crank and the gate at the bottom of the hopper (i.e. dump gate). The input from the pilot runs through a booster which delivers the force to help open and close the gate. If the booster fails, the pilot can still mechanically operate the gate with just the added friction of the booster. This maintains safety even during failure.

In an exemplary embodiment of the present invention, there is disclosed a booster for assisting a pilot to open and close a dump gate of a crop duster aircraft. Said booster can be located anywhere in between the pilot's input bell crank and the dump gate. Said booster can be driven by a variety of power source including but not limited to hydraulic, pneumatic, and electric.

In an exemplary embodiment of the present invention, the booster is a hydraulic booster, including a hydraulic pump, hydraulic accumulator, hydraulic pressure regulator, and a hydraulic cylinder.

In an exemplary embodiment of the present invention, the booster has at least 3 connection points: the input side of the booster connected to the pilot's input bell crank side of linkage(s), the output side of the booster connected to the dump gate side of the linkage(s), and the third connection point of the booster is anchored to the frame of the crop duster. When the booster pushes against the third anchor point to boost the pilot's input, resulting in a larger force towards the dump gate, the pilot can open and close the dump gate with less physical effort.

In an exemplary embodiment of the present invention, there is disclosed a method for assisting a pilot to control a duster dump gate. The method includes following steps: (a) hydraulically connect the pump accumulator and regulator to the booster with pipes or hoses; (b) electronically connect the pump to the aircraft power bus through a circuit breaker using appropriately sized and sourced wire; (c) mount the pump accumulator and regulator inside the fuselage of the plane; (d) replacing the original linkage(s) that went between the pilots input bell crank and the lower bell crank with the booster. The booster has three connection points and the original linkage only had two connection points; (e) connect the linkage of the input side of the booster to the pilot's input bell crank via a first anchor, connect the linkage of the output side of the booster to the lower bell crank via a second anchor, and connect to the third connection point to the frame of the crop duster via a third anchor; wherein the booster pushes against the third anchor point to boost the pilot's input, resulting in a larger force towards the dump gate.

It is important to note that a motor and gearbox is referred to as backdrivable if it is possible to rotate the output of the gearbox while the motor is off. Additionally, in many instances a crop duster can be simultaneously referred to as a fire bomber. Such as in the Case of the AT-802, it can be a crop duster or a fire bomber, it just depends on what load is being dropping out of the aircraft itself.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates a crop duster having a powered dump gate system according to an exemplary embodiment of the present invention; and

FIG. 2 illustrates a block diagram of a hydraulic booster according to an exemplary embodiment of the present invention.

### DESCRIPTION OF THE PREFERRED EMBODIMENT

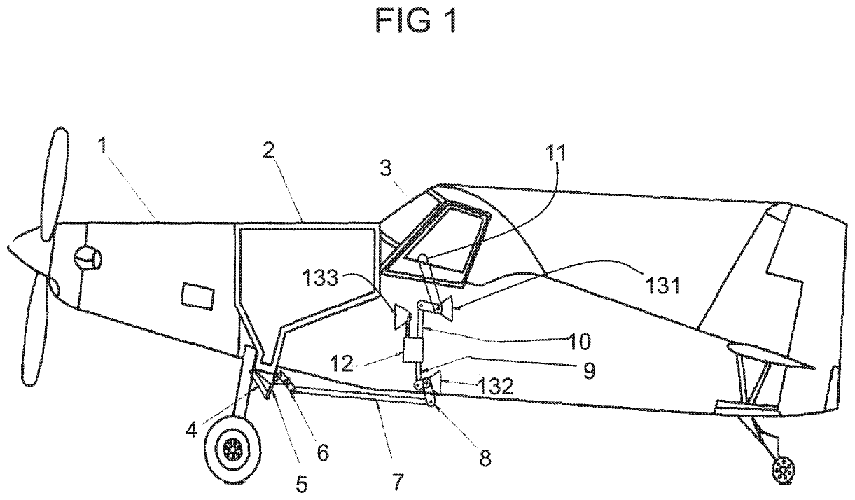

FIG. 1 illustrates a powered dump gate system 100 installed in a crop duster according to an exemplary embodiment.

As shown in FIG. 1, the crop duster airplane 1 has a payload hopper 2, normally in the fuselage over the spar. At the bottom of the payload hopper is the dump gate 4. In the cockpit 3 is the pilot's input bell crank (the first bell crank) 11, which is the control lever in the cockpit used by the pilot to control the dump gate 4. The lower end of the pilot's input bell crank 11 is secured to a first anchor 131 and is connected to the linkage on the booster input side (the first linkage) 10 via the anchor 131. The linkage on the booster output side (the second linkage) 9 is connected to the lower bell crank (the second bell crank) and a backdrivable servo 8 via a second anchor 132. The lower bell crank and backdrivable servo 8 is connected to the lower horizontal linkage (the third linkage) 7. The lower end of the lower horizontal linkage is connected to the upper end of the over center bell crank (the third bell crank) 6. The lower end of the over center bell crank is connected to the over center linkage (the fourth linkage) 5. The over center linkage 5 is then connected to the dump gate 4. Moreover, the booster 12 is connected to an anchor point 133 on the frame of the crop duster to push or pull against. The booster 12 is controlled by the input bell crank side of linkage(s). All the bell crank's center pivot points are held to the crop duster via anchor points 131 and 132.

In one aspect, disclosed herein is a booster 12 for assisting pilot to open and close the dump gate 4 of a crop duster 1.

The booster 12 takes an input from the pilot, then creates a boosted response through the output side to assist operation of the dump gate.

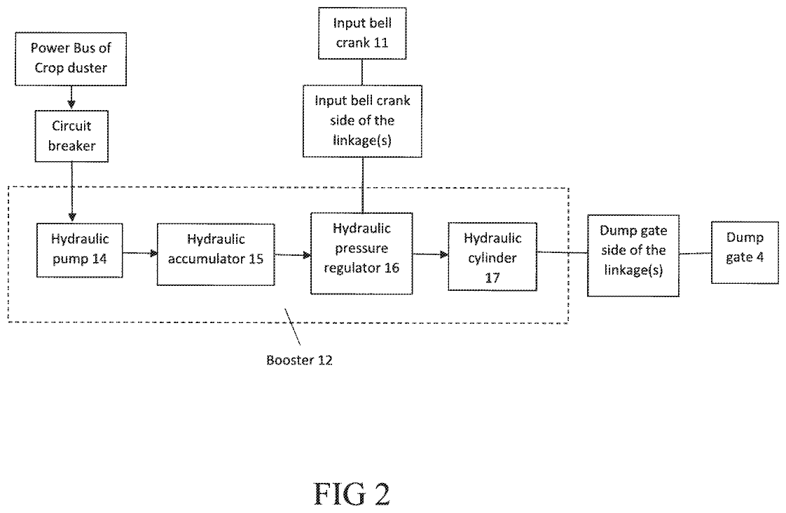

According to some embodiments as illustrated in FIG. 2, the booster 12 is a hydraulic booster, comprising a hydraulic pump 14, which creates hydraulic pressure; a hydraulic accumulator 15, which is a pressure storage reservoir; a hydraulic pressure regulator 16, which limits the output of hydraulic fluid to maintain a desired pressure, and a hydraulic cylinder 17, which is a mechanical actuator that is used to give a unidirectional force through a unidirectional stroke.

According to some embodiments, the hydraulic pressure regulator 16 receives input from pilot's input bell crank and sends the output to the hydraulic cylinder 17, which then delivers force towards the dump gate side of linkage(s) to help control operation of dump gate. A backdrivable servo is connected to the lower bell crank as the booster. What this means is that the Backdrivability will allow the servo to rotate if the system fails, so there is minimal drag of the failed servo. This is allows for safe failures.

The hydraulic pump 14 is mounted in the airplane and connected to the hydraulic accumulator 15 which is connected to the hydraulic pressure regulator 16 which feeds regulated hydraulic power to the hydraulic cylinder 17. When the crop duster 1 is powered on, the hydraulic pump 14 builds and stores hydraulic pressure in the hydraulic accumulator 15. The hydraulic pressure regulator 16 transfers power to the hydraulic cylinder 17. When the crop duster 1 is in flight and has product in the hopper 2, the dump gate 4 opens and closes controlling the flow of the product during application. The pilot, in the cockpit 3, uses his input bell crank 11 to control the position of the dump gate 4. Along the path of linkages from the input bell crank to the dump gate is the hydraulic booster 12. The input side of the booster 12 is connected to the input bell crank side of the linkage(s). The output side of the booster 12 is connected to the dump gate side of the linkage(s). When the pilot moves the input bell crank the hydraulic booster senses the movement and matches this motion. As the booster moves itself, it will quickly apply to its full force to match the input movement. The booster movement is sent through the rest of the control linkage(s) to the dump gate.

According to some embodiments, the booster 12 can be located anywhere in between the pilot's input crank 11 and the dump gate 4.

According to some embodiments, the boosting 12 may further comprises optional check valve to the pump and a pressure switch on the accumulator so the pump will shut off when no movement is being made.

According to some embodiments, the booster 12 can be driven by different source of power such as pneumatic or electric.

According to some embodiments, the booster 12 is an electric booster, wherein the pilot's input bell crank 11 is connected to the lower bell crank 8. The force on the input linkage is measured and used as the input into the booster. A clutched servo is then connected to the lower bell crank as the booster. The clutch allows the servo to disengage if the system fails, so there is no drag of the failed servo, allowing for safe failures.

In another aspect, disclosed herein is a powered crop dump gate system 100 for assisting pilot to control the dump gate 4 of a crop duster 1.

According to some embodiments, the powered crop dump gate includes pilot's input bell crank (the first bell crank) 11; pilot's input bell crank side of linkage(s); booster 12; and dump gate side of linkage(s).

According to some embodiments, the input bell crank side of linkage(s) include the first anchor 131, and the linkage on the input side of the booster (the first linkage) 10; and the dump gate side of linkage(s) include the linkage on the output side of the booster (the second linkage) 9; the second anchor 132, the lower bell crank (the second bell crank); the lower horizontal linkage (the third linkage) 7; the over center bell crank (the third bell crank) 6; the over center linkage (the fourth linkage) 5. The lower end of the over center linkage is connected to the dump gate.

According to some embodiments, the booster may be powered by hydraulic, pneumatic, or electric.

According to some embodiments, the booster is a hydraulic booster, comprising hydraulic pump 14, hydraulic accumulator 15, hydraulic pressure regulator 16; and hydraulic cylinder 17.

In another aspect, the described invention provides a method 200 for assisting pilot to open and close the dump gate 4 of a crop duster 1.

According to some embodiments of the method, the method 200 comprises following steps: (a) hydraulically connecting the pump accumulator 15 and regulator 16 to the booster 12 with pipes or hoses; (b) electronically connecting the pump 14 to the aircraft power bus through a circuit breaker using appropriately sized and sourced wire; (c) mounting the pump accumulator 15 and regulator 16 inside the fuselage of the plane; (d) replacing the original linkage(s) that went between the pilots input bell crank 11 and the lower bell crank 8 with the booster 12, (the booster has 3 connection points and the original linkage only had 2); (e) connecting the linkage of the input side 10 of the booster to the pilot's input bell crank 11 via a first anchor 13, connecting the linkage of the output side 9 of the booster to the lower bell crank 8 via a second anchor 13, and connecting to the third connection point to the frame of the crop duster via a third anchor 13; wherein the booster 13 pushes against the third anchor point to boost the pilot's input, resulting in a larger force towards the dump gate 4. Once the installation is complete, energize the circuit breaker and the system will power the pump and start working.

According to some embodiments, the method 200 further comprises steps of adding optional check valve to the pump; and adding a pressure switch on the accumulator 15 so the pump 16 will shut off when no movement is being made.

According to some embodiments of the method 200, the source of power used to drive the booster may be pneumatic or electric.

An embodiment method for an electric installation would be changing from a linear to rotational booster. In this installation, the input side linkage(s) goes from the pilot's input bell crank to the lower bell crank. The force on the input linkage is measured and used as the input into the booster. A clutched servo is then connected to the lower bell crank as the booster. The clutch allows the servo to disengage if the system fails, so there is no drag of the failed servo, allowing for safe failures.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A booster system for assisting a pilot to operate the controls of a dump gate of a crop duster, said crop duster having a pilot's input bell crank which is a control lever in a cockpit used by the pilot to control the dump gate, the booster system comprising:
a booster located anywhere in between the pilot's input bell crank and the dump gate.

2. The booster system of claim 1, wherein the booster connects on its input side to pilot's input bell crank side of the linkage(s), connects on its output side to dump gate side of the linkage(s), and connects to the frame of the crop duster via an anchor.

3. The booster of claim 1, wherein the booster takes an input from the pilot, then creates a boosted response through the output side to assist operation of the dump gate.

4. The booster system of claim 1, wherein the booster system can be driven by a variety of power source including but not limited to hydraulic, pneumatic, and electric.

5. The booster system of claim 1, wherein the booster is a hydraulic booster, comprising a hydraulic pump; a hydraulic accumulator; a hydraulic pressure regulator; and a hydraulic cylinder; the hydraulic pump is mounted in the crop duster and connected to the hydraulic accumulator which is connected to the hydraulic pressure regulator which feeds regulated hydraulic power to the hydraulic cylinder which send power through the dump gate side of the linkage(s) to help control the dump gate.

6. The booster system of claim 1, wherein the booster is an electric booster, the pilot's input bell crank is connected to a lower bell crank, the force on the input linkage is measured and used as the input into the booster, a clutched servo is connected to the lower bell crank as the booster; the clutch allows the servo to disengage if the system fails, so there is no drag of the failed servo, allowing for safe failures.

7. The booster system of claim 1, wherein the booster is an electric booster, the pilot's input bell crank is connected to a lower bell crank, the force on the input linkage is measured and used as the input into the booster, a backdrivable servo is connected to the lower bell crank as the booster; the backdrivability allows the servo to rotate if the system fails, so there is minimal drag of the failed servo, allowing for safe failures.

8. A method for assisting a pilot to operate the controls of a dump gate of a crop duster aircraft using a pilot's input bell crank, the method comprising following steps:
(a) electronically connecting an electric servo booster to the aircraft power bus through a circuit breaker;
(b) mounting the electric servo booster on or in the fuselage of the aircraft; and
(c) connecting at a first connection point on the input side of the booster to the pilot's input bell crank via linkage(s) and anchor(s), connecting at a second connection point on the output side of the booster to a lower bell crank via linkage(s) and anchor(s), and connecting at the third connection point to the frame of the crop duster aircraft via an anchor;
whereby the booster pushes against the third anchor point to boost the pilot's input, resulting in a larger force towards the dump gate.

9. A method for assisting a pilot to operate the controls of a dump gate of a crop duster aircraft using a pilot's input bell crank, the method comprising following steps:
(a) connecting a hydraulic pump, a hydraulic accumulator and a hydraulic pressure regulator to a booster with pipes or hoses;
(b) electronically connecting the hydraulic pump to the aircraft power bus through a circuit breaker;
(c) mounting the hydraulic pump, hydraulic accumulator and hydraulic pressure regulator inside the fuselage of the plane; and
(d) connecting at a first connection point on the input side of the booster to the pilot's input bell crank via linkage(s) and anchor(s), connecting at a second connection point on the output side of the booster to a lower bell crank via linkage(s) and anchor(s), and connecting at the third connection point to the frame of the crop duster aircraft via an anchor;
whereby the booster pushes against the third anchor point to boost the pilot's input, resulting in a larger force towards the dump gate.

10. The method of claim 9 further comprising a step of removing linkage(s) that originally exist between the pilot's input bell crank and the lower bell crank in the crop duster aircraft prior to the step (d) connecting at a first connection point on the input side of a booster to the pilot's input bell crank via linkage(s) and anchor(s), connecting at a second connection point on the output side of the booster to a lower bell crank via linkage(s) and anchor(s), and connecting at the third connection point to the frame of the crop duster aircraft via an anchor.
